(19) United States
(12) Patent Application Publication
(10) Pub. No.: US 2015/0244104 A1
(43) Pub. Date: Aug. 27, 2015

(54) DOOR CONNECTOR FOR VEHICLE

(71) Applicants: HYUNDAI MOTOR COMPANY, Seoul (KR); Kia Motors Corporation, Seoul (KR); TYCO ELECTRONICS AMP KOREA LTD., Gyeongsan-si (KR)

(72) Inventors: Sung Kwan CHOO, Hwaseong-si (KR); Jong Pil CHOI, Hwaseong-si (KR); Keun Sung SONG, Gyeongsan-si (KR); Gi Chan KWON, Gyeongsan-si (KR); Chang Jae CHOI, Gyeongsan-si (KR)

(21) Appl. No.: 14/569,479

(22) Filed: Dec. 12, 2014

(30) Foreign Application Priority Data
Feb. 21, 2014 (KR) 10-2014-0020655

(51) Int. Cl. H01R 13/58; H01R 13/629

(52) U.S. Cl. CPC H01R 13/58; H01R 13/62905

(57) ABSTRACT

A door connector of a vehicle supplies electric power and signals to an electrical component that is mounted in a vehicle door. The door connector includes a cap which is installed on a vehicle body panel. A plug assembly is extended from a door side, and coupled and electrically connected to the cap. A grommet protects a wire connected to the plug assembly. The plug assembly may include a plug cover. The plug cover has a grommet connector to which the grommet is coupled and has a vertical passage shape through which the wire is withdrawn downward. The plug cover accommodates a plug therein through a front surface of the plug. The plug is coupled to the cap through the front surface thereof, has a rear surface to which the wire is connected, and is coupled inside the plug cover by a fastening structure.

### CROSS-REFERENCE TO RELATED APPLICATION

This application claims under 35 U.S.C.§119(a) the benefit of priority to Korean Patent Application No. 10-2014-0020655 filed on Feb. 21, 2014, the entire contents of which are incorporated herein by reference.

### TECHNICAL FIELD

The present disclosure relates to a door connector for a vehicle. More particularly, it relates to a connector that is used to supply electric power and signals to electrical components mounted in a vehicle door.

### BACKGROUND

In general, various types of electrical components, such as a power window device, a locking device, a lighting device, a side mirror steering device, and an airbag operating device, are mounted in a door of a vehicle. These electrical components are connected with a power source of the vehicle by wires and operated by electric power supplied.

As a connecting mechanism, connectors are used when connecting the wires with door side electrical components for convenience of wiring work and for a waterproof structure.

That is, the connectors connect signals between a power source of a battery and other units with a waterproof structure in order to supply electric power and signals to various types of electrical components mounted in the vehicle door.

Typically, a door connector has a pair of connectors including a cap and a plug. The door connector has a structure in which the cap, which is extended from a power source side, is fastened to a vehicle body, and the plug, which is extended from a door side electrical component, is coupled to the cap.

Various forms of connectors are disclosed in Korean Patent Application Laid-Open No. 10-2009-0112479, Korean Patent No. 10-1106671, and the like.

Typically, the connector needs to have a space formed between the vehicle body and a door panel and needs a waterproof function to prevent inflow of external water and foreign substances such as dust.

For the purpose of the waterproof function, a waterproof seal needs to be separately provided in the connector.

FIG. 6 is a schematic cross-sectional view illustrating a door connector for a vehicle in the related art.

As illustrated in FIG. 6, a door connector in the related art includes: a cap 100 which is fixed to a vehicle body panel 140; a plug 110 which is extended from a door panel side; and a grommet 120 for waterproofing. The plug 110 is electrically connected while being coupled to the cap 100 which is disposed on a vehicle body.

Here, non-described reference numeral 130 indicates a lever for easily coupling the cap 100 and the plug 110. Non-described reference numeral 150 indicates an elastic protrusion that is caught by an edge of a hole 160 formed in the vehicle body panel 140.

However, the door connector for a vehicle in the related art has several problems as follows:

In the case of a rear door, a gap between the vehicle body and the door panel is insufficient by 10˜20 mm in comparison with a front door, and an amount at which the connector protrudes rearward is excessive, such that it is impossible to apply the connector.

In the case of the current structure of the connector in which the plug and the grommet are directly fastened, there may be a problem in that the grommet coupled to the plug is pulled out by stress of wires in the grommet due to the movement of the door.

As illustrated in FIG. 7, in the fastening structure of the cap and the vehicle body, a gap between the vehicle body hole and the cap is excessive because an operation distance of the elastic protrusion is long, and as a result, the cap is often fastened in an opposite direction due to a small overlap amount when the connector is fastened in a reverse direction.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to resolve the above-described problems associated with the prior art. An aspect of the present disclosure provides a door connector for a vehicle, which may reduce the number of assembly processes of the connector and apply a waterproof structure in a relatively small space between a vehicle body and a door panel by improving a coupling structure between a plug and a grommet, and a fastening structure of a cap.

Another aspect of the present disclosure provides a door connector for a vehicle, which may improve maintainability by a combination structure of a plug and a plug housing that may be disassembled.

In order to achieve the aforementioned object, a door connector for a vehicle provided by the present invention has the following features.

In an exemplary embodiment of the present disclosure, a door connector for a vehicle is provided, which is used to supply electric power and signals to an electrical component mounted in a vehicle door. The door connector includes a cap which is installed on a vehicle body panel. A plug assembly is extended from a door side, and coupled and electrically connected to the cap. A grommet protects a wire connected to the plug assembly. The plug assembly may include a plug cover. The plug cover has a grommet connector to which the grommet is coupled and has a vertical passage shape through which the wire is withdrawn downward. The plug cover accommodates a plug therein through a front surface of the plug. The plug is coupled to the cap through the front surface thereof, has a rear surface to which the wire is connected, and is coupled inside the plug cover by a fastening structure.

The cap of the door connector may include a plurality of elastic protrusions fastened to the vehicle body panel. The elastic protrusion may be caught and released while being operated toward the interior of a cap body when the elastic protrusions are fastened to the vehicle body panel.

An outer periphery of a cap body of the cap and an outer periphery of a cap installation hole formed in the vehicle body panel for installing the cap may be formed in the same shape that is asymmetric about a horizontal axis.

The plug assembly may further include a lever which pulls the plug toward the cap using a guide protrusion that is moved along a guide groove disposed in the cap while being operated upward and downward depending on a manipulation of a user when the cap and the plug are coupled.

According to the present disclosure, by restricting a traveling direction of the wire connected to the plug by setting a direction in which the wire is withdrawn to a downward direction, and by allowing the plug cover to absorb stress transmitted to the grommet, the door connector may reduce an amount at which the connector protrudes by 30˜40% in comparison with the related art such that the connector may be efficiently applied even in a small space such as a rear door.

Further, according to the present disclosure, an amount at which the cap body and the cap installation hole overlap each other is sufficiently ensured when the cap body and the cap installation hole are abnormally fastened.

The door connector for a vehicle provided by the present invention has the following advantages:

The connector may be used even in a small space in a rear door by changing a structure of the connector, thereby resolving problems with insertion of the connector in a reverse direction and difficulty in performing maintenance.

Difficulty in fastening a rear door connector, which is performed by fastening the current connector and then separately assembling the grommet, may be resolved, thereby reducing costs due to stoppage in a production line.

Other aspects and preferred embodiments of the invention are discussed infra.

It is understood that the term “vehicle” or “vehicular” or other similar terms as used herein is inclusive of motor vehicles in general, such as: passenger automobiles including, sports utility vehicles (SUV), buses, trucks, various commercial vehicles; watercraft including; a variety of boats and ships, aircraft, and the like: and includes, hybrid vehicles, electric vehicles, plug-in hybrid electric vehicles, hydrogen-powered vehicles, and other alternative fuel vehicles (e.g., fuel derived from resources other than petroleum). As referred to herein, a hybrid vehicle is a vehicle that has two or more sources of power, for example, both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention.

FIGS. 1A and 1B are coupled perspective views illustrating a door connector for a vehicle according to an exemplary embodiment of the present disclosure.

FIGS. 2A and 2B are exploded perspective views illustrating the door connector for a vehicle according to the exemplary embodiment of the present disclosure.

FIG. 3 is a cross-sectional perspective view illustrating the door connector for a vehicle according to the exemplary embodiment of the present disclosure.

FIG. 4 is a cross-sectional view illustrating a fastening structure for an elastic protrusion in the door connector for a vehicle according to the exemplary embodiment of the present disclosure.

FIG. 5 is a rear view illustrating a structure for improving an abnormal fastening state in the door connector for a vehicle according to the exemplary embodiment of the present disclosure.

FIG. 6 is a schematic cross-sectional view illustrating a door connector for a vehicle in the related art.

FIG. 7 is a rear view illustrating an abnormal fastening state in the door connector for a vehicle in the related art.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, reference will now be made in detail to various embodiments of the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention will be described in detail with reference to the accompanying drawings.

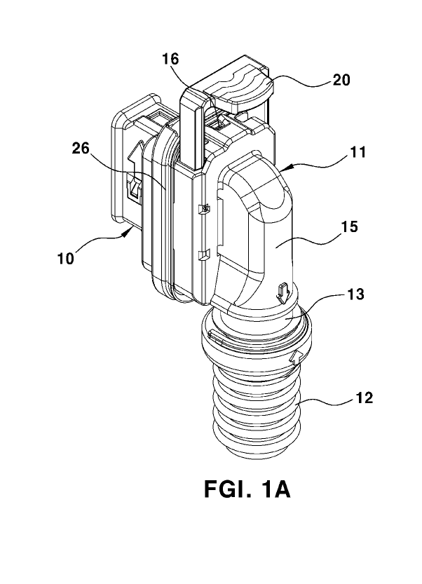

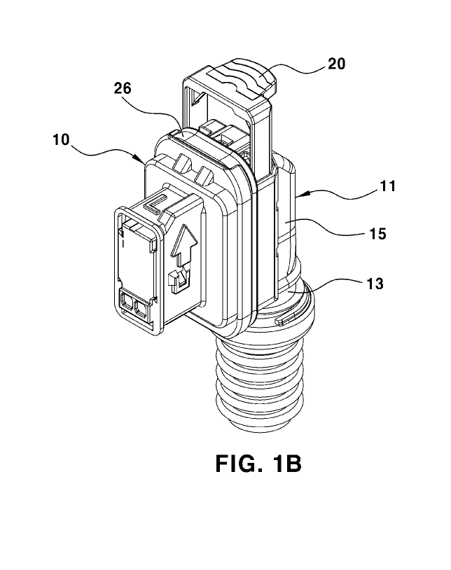

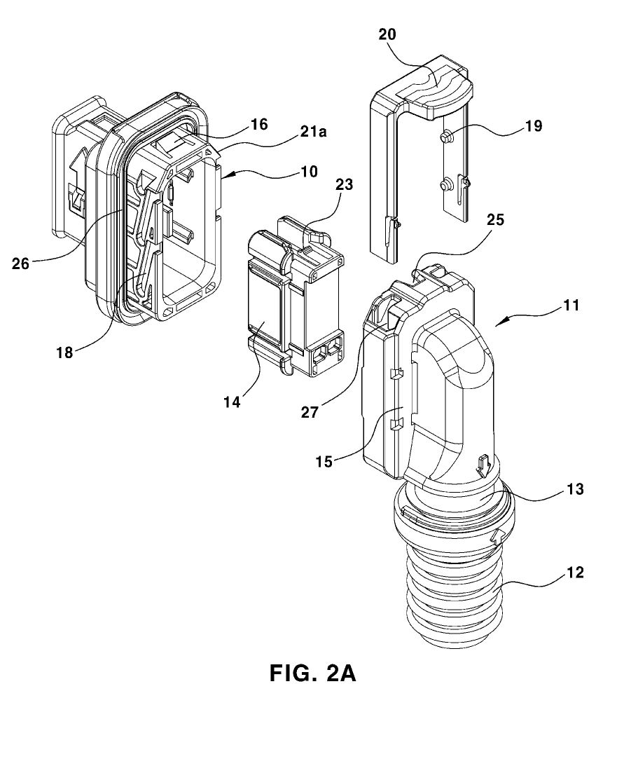

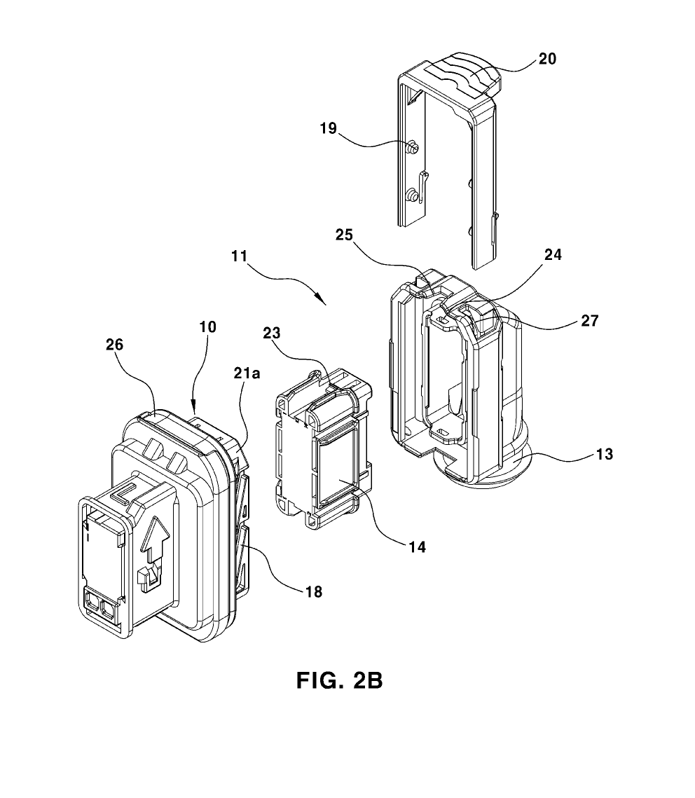

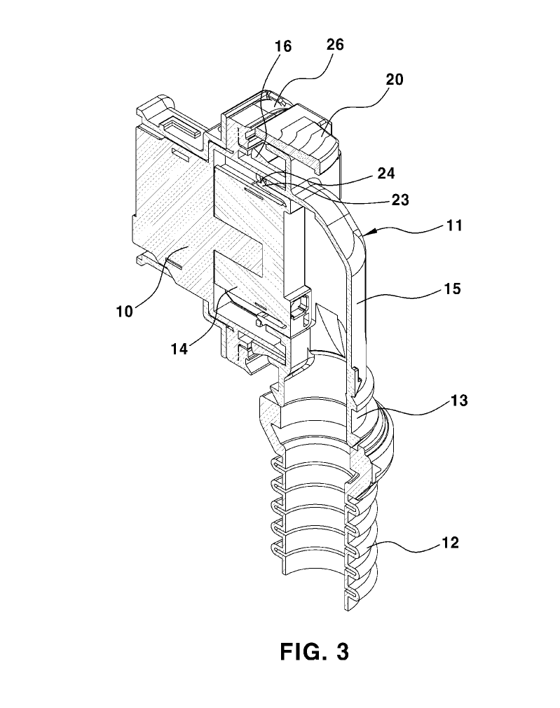

FIGS. 1A and 1B are coupled perspective views illustrating a door connector for a vehicle according to an exemplary embodiment of the present disclosure. FIGS. 2A and 2B are exploded perspective views illustrating the door connector for a vehicle according to the exemplary embodiment of the present disclosure. FIG. 3 is a cross-sectional perspective view illustrating the door connector for a vehicle according to the exemplary embodiment of the present disclosure.

As illustrated, the door connector is used to supply electric power and signals to various types of electrical components mounted in a vehicle door. The door connector includes a cap 10 which is installed on a vehicle body panel (not shown), a plug assembly 11 which is coupled and electrically connected to the cap 10, and a grommet 12 which protects wires connected to the plug assembly 11.

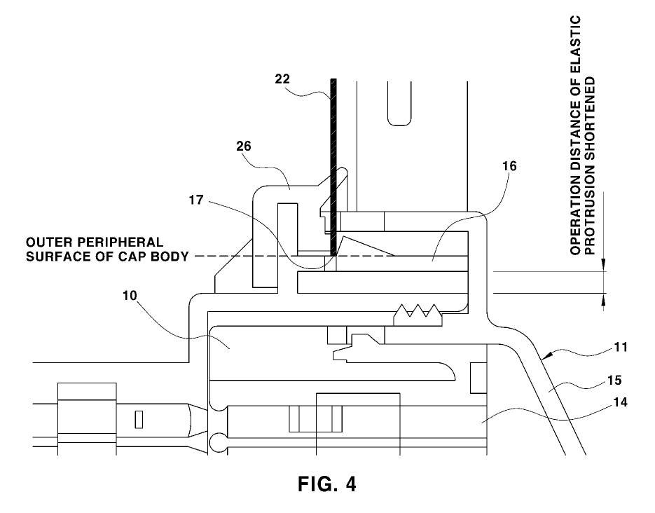

The cap 10 is a part that is electrically connected to a power source such as a battery and fixed in a cap installation hole 17 formed in the vehicle body panel (see FIG. 4).

To this end, elastic protrusions 16 having wedge-shaped catching portions are formed on upper and lower surfaces of a cap body of the cap 10, respectively. When the cap body is inserted into the cap installation hole 17, the cap 10 may be installed by an edge end of the cap installation hole 17 while the elastic protrusion 16 is pressed and then restored.

Particularly, the elastic protrusion 16 has a structure that is caught and released while being operated (while being pressed or restored) toward the interior of the cap body from the upper surface or the lower surface of the cap body when the elastic protrusion 16 is fastened to the vehicle body panel, and as a result, an moving distance may be shortened in comparison with the elastic protrusion in the related art which protrudes to the outside of the cap body.

For example, as illustrated in FIG. 4, in the case of the connector of the present disclosure, the operation distance of the structure of the elastic protrusion 16 of the cap which is fixed to the vehicle body is shortened, that is, a movement position of the elastic protrusion 16 is set to be opposite to that of the elastic protrusion 16 of the existing connector. The elastic protrusion 16 is operated by using an internal space on the basis of an outer peripheral surface of the cap body, such that a size of the cap installation hole 17 may be identical to a size of the cap body.

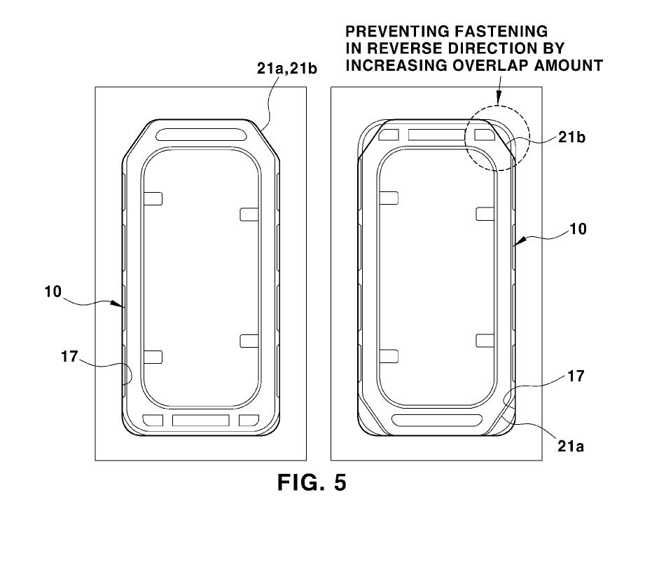

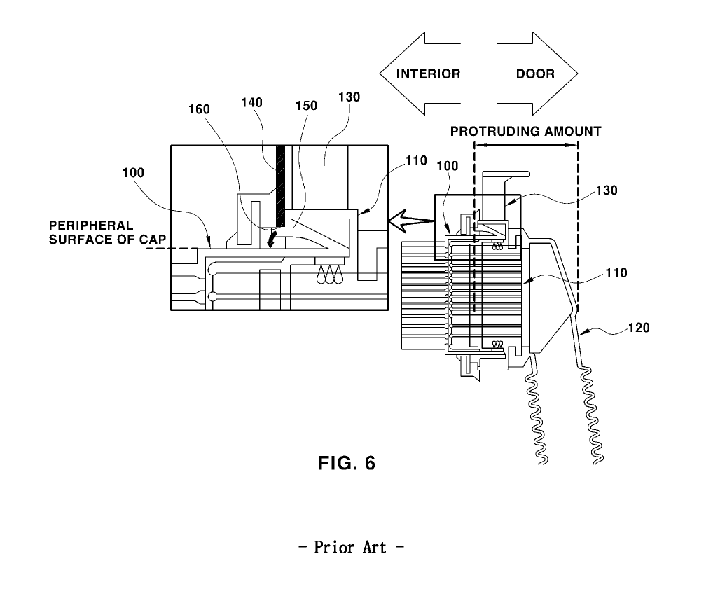

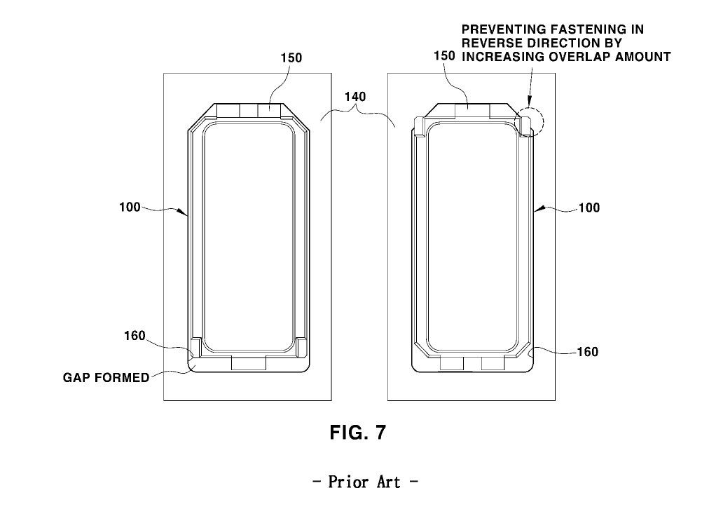

Accordingly, as illustrated in FIG. 5, since a gap between the connector and the cap installation hole 17 may be minimized, an overlap amount may be increased in a case in which the connector is abnormally fastened while upper and lower portions thereof are reversed, thereby solving a problem with the abnormal fastening of the connector.

In this regard, an outer periphery of the cap body of the cap 10 and an outer periphery of the cap installation hole 17, which is formed in the vehicle body panel for installing the cap, have the same asymmetric shape. For example, the outer periphery of the cap body of the cap 10 and the outer periphery of the cap installation hole 17 have the same shape that is asymmetric about a horizontal axis, in which inclined surfaces 21a and 21b are formed at two upper corners of both the cap body and the cap installation hole 17. Therefore, it is possible to ensure a sufficient overlap amount (an amount at which the cap body and the cap installation hole 17 overlap each other when the cap body is inserted into the cap installation hole 17) in a case in which the cap body is matched with the cap installation hole while reversing upper and lower portions of the cap, thereby improving the abnormal fastening of the connector.

A sealing cover body 26, which serves as a means for ensuring watertightness, is provided in the cap 10. In this case, the sealing cover body 26 has an area larger than that of the cap body and is coupled along a circumference of the cap body of the cap 10. The sealing cover body 26 further serves to protect a connection portion between the cap 10 and the plug 14 while being in close contact with the vehicle body panel 22 when the cap is installed.

The plug assembly 11 is electrically connected with various types of electrical components of the door and installed on the vehicle body panel 22.

The plug assembly 11 has a combination of the plug 14 for coupling the cap 10, and a plug cover 15 that accommodates the plug 14.

The plug 14 is electrically connected to the cap 10 by a front surface thereof that is fitted with the cap 10, and a plurality of wires, which are extended from the door side electrical component, are connected to a rear surface of the plug 14. Since the plug 14 is detachably coupled to the plug cover 15 by fastening, there is an advantage in that maintenance of the connector may be easily performed.

Fastening protrusions 23 are formed at upper and lower ends of the plug 14, respectively, and fastening holes 24 in which the fastening protrusions 23 are locked and unlocked are formed in an upper end portion and a lower end portion inside the plug cover 15, respectively.

Accordingly, when the plug 14 is inserted into the plug cover 15, the fastening protrusion 23 may be coupled and fastened to the fastening hole 24 of the plug cover 15, and when the fastening protrusion 23 and the fastening hole 24 are released from each other, the plug cover 15 may be easily separated from the plug 14.

In this case, cut-out grooves 25 are formed at upper and lower ends of the plug cover 15, and a tool may be inserted into fastened portions between the fastening protrusion 23 and the fastening hole 24 which are exposed through the cut-out grooves 25, thereby easily releasing the fastened state between the fastening protrusion 23 and the fastening hole 24.

In the related art, a grommet and a connector need to be completely separated from a vehicle body in order to perform maintenance of terminals in a connector. However, in the present disclosure, maintenance may be more easily performed because of the structure in which the plug 14 and the plug cover 15 are separated from each other.

The grommet connector 13, which is a passage for introducing the wire and a part to which the grommet 12 is connected, is formed in the lower end portion of the plug cover 15, and particularly, the grommet connector 13 is formed in a vertical passage shape through which the wire may be withdrawn downward.

Accordingly, a traveling direction of the wire is restricted by setting a direction in which the wire is withdrawn at the plug cover side to a downward direction, and as a result, the plug cover may absorb stress transmitted to the grommet.

For example, because a grommet is horizontally coupled to a rear surface of a plug housing in the related art, a coupled portion of the grommet is peeled off due to stress of a wire inside the grommet (horizontal force applied to an inner surface of the grommet while the wire is bent) such that the grommet is often pulled out, and in order to prevent the grommet from being pulled out, a sufficient protruding amount needs to be ensured at a rear side of the plug housing (which causes an amount at which the connector protrudes to become large).

However, in the present disclosure, the plug cover itself receives stress of the wire, and the grommet 12 is coupled to the grommet connector 13 that is directed in a vertical direction at the lower end of the plug cover 15, and thus, a problem that the grommet is pulled out may be resolved by allowing the plug cover 15 to absorb stress of the wire (by preventing the grommet from receiving stress of the wire), and it is possible to reduce an amount at which the connector protrudes by 30˜40% in comparison with the related art.

A lever 20, which is a means for helping the cap 10 and the plug 14 be smoothly coupled by only using a small amount of force when the cap 10 and the plug 14 are coupled, is provided in the plug assembly 11. The lever 20 is mounted to the plug cover 15 while being inserted into lever holes 27 formed at both sides of the upper end portion of the plug cover 15, and may be moved upward and downward while being guided along guide grooves 18 formed in the cap 10 by using guide protrusions 19 formed on inner surfaces of both vertical members.

When the lever 20 is pushed downward in a state in which the cap 10 and the plug 14 face each other, and the guide protrusion 19 disposed on the lever 20 is inserted into the guide groove 18 disposed in the cap 10 when the plug 14 is coupled to the cap 10 at the vehicle body side, the guide protrusion 19 of the lever 20 moves downward along the guide groove 18 having a structure that is inclined downward toward a rear side of the cap, and as a result, the plug 14 and the cap 10 may be easily coupled while the entire plug 14 including the plug cover 15 is pulled toward the cap 10.

As such, the present disclosure implements a new type of connector including a structure in which the plug and the plug cover may be separated and coupled, a structure in which the grommet is connected to a lower portion of the plug cover, and a structure in which an operation direction of the elastic protrusion is set to an inward direction of the cap when the cap is installed, such that the protruding amount may be improved in comparison with the existing connector, thereby easily applying the connector even in a small space such as the rear door, resolving the problem that the grommet is pulled out, and resolving a problem with abnormal fastening and difficulty in performing maintenance.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A door connector for a vehicle for supplying electric power and signals to an electrical component mounted in a vehicle door, the door connector comprising:
a cap which is installed on a vehicle body panel;
a plug assembly which extends from a door side, and is coupled and electrically connected to the cap; and
a grommet which protects a wire connected to the plug assembly,
wherein the plug assembly includes:
a plug cover which has a grommet connector to which the grommet is coupled and which has a vertical passage shape through which the wire is withdrawn downward, and accommodates therein a plug through a front surface thereof; and
a plug which is coupled to the cap through the front surface thereof, has a rear surface to which the wire is connected, and is coupled inside the plug cover by fastening.

2. The door connector of claim 1, wherein the cap includes a plurality of elastic protrusions fastened to the vehicle body panel, and the elastic protrusion is caught and released while being pressed or restored toward the interior of a cap body when the elastic protrusions are fastened to the vehicle body panel.

3. The door connector of claim 1, wherein an outer periphery of a cap body of the cap and an outer periphery of a cap installation hole formed in the vehicle body panel for installing the cap are asymmetric about a horizontal axis.

4. The door connector of claim 1, wherein the plug assembly further includes a lever which pulls the plug toward the cap using a guide protrusion that moves along a guide groove disposed in the cap while being operated upward and downward when the cap and the plug are coupled.

5. The door connector of claim 2, wherein the cap further includes a sealing cover body for ensuring watertightness, and the sealing cover body has an area larger than that of the cap body and is coupled along a circumference of the cap body.

6. The door connector of claim 5, wherein the sealing cover protects a connection portion between the cap and the plug while being in close contact with the vehicle body panel when the cap is installed.

7. The door connector of claim 3, wherein two upper corners of both the cap body and the cap installation hole have inclined surfaces.

8. The door connector of claim 1, wherein the plug assembly further includes:
fastening protrusions formed at upper and lower ends thereof, respectively;
fastening holes are formed in an upper end portion and a lower end portion inside the plug cover, respectively; and
lever holes formed at both sides of an upper end portion of the plug cover.

9. The door connector of claim 8, wherein the plug assembly further includes cute-out grooves formed upper and lower ends of the plug cover.
